(19) United States
(12) Patent Application Publication
(10) Pub. No.: US 2011/0114672 A2
(43) Pub. Date: May 19, 2011

(54) APPARATUS AND METHOD FOR EXTRUDING A PRODUCT

(75) Inventors: FRANCOIS BOUDY, Cenon sur Vienne (FR); ANDRE BUSOLIN, Thenezay (FR)

(73) Assignee: CADBURY SCHWEPPES PLC, LONDON (UK)

(21) Appl. No.: 11/720,467

(22) Filed: Jun. 12, 2007

(30) Foreign Application Priority Data
Jun. 8, 2006 (UK) PCT/GB2005/004575
Nov. 30, 2004 (UK) GB 0426220.0

(51) Int. Cl. B65D 35/22; B67D 5/60

(52) U.S. Cl. 222/145.3; 222/145.6

(57) ABSTRACT

An apparatus and a method for producing a striped confectionery product is provided. The apparatus may co-extrude two different base products into a common flow path, including elongate openings extending laterally across the flow path generally parallel to one another through which the base products are introduced so as to form a combined co-extruded product. A die can receive the layered co-extruded product stream, the die having a generally helical blade statically mounted in the passage to divide the passage into two generally helical flow paths. The die can be configured so that the sub-streams can be subsequently recombined into a single recombined product stream having an increased number of generally parallel layers of the base products when compared with the initial co-extruded product stream.

### CROSS-REFERENCE TO RELATED APPLICATIONS

This application is the national stage filing under 35 U.S.C. §371 of PCT/GB2005/004575, filed Nov. 30, 2005, which claims priority to GB 0426220.0, filed Nov. 30, 2004, which is incorporated herein by reference.

### FIELD OF THE INVENTION

The present invention relates to an apparatus and method for producing striped or variegated product from two or more different base products. The apparatus and method are particularly, but not exclusively, suited for use in producing a striped or variegated confectionary product.

### BACKGROUND OF THE INVENTION

The development of attractive new products for confectionary includes the development of new shapes, new visual effects, and a combination of tastes and textures.

It is known to produce confectionary made of two different products to produce a striped effect. A striped effect can be produced using products having different colours. For example, two different coloured gums can be combined to produce a striped gum product. Alternatively, or additionally, two products having a different texture and/or taste can be combined. An example of this would be to combine a gum and a soft chew to produce a striped or variegated product.

Extrusion systems are known that can be used to combine two different base products, such as different coloured gums, to produce a confectionary product with a striped effect. However, the known systems are complex and tend to be rather expensive.

There is a need then for an apparatus and method that can combine two or more different base products to form a product having a striped or variegated appearance and which are simpler and cheaper than the prior art apparatus and methods

### SUMMARY OF THE INVENTION

According to a first aspect of the invention, there is provided apparatus for producing a striped or variegated product comprises means for co-extruding at least two different base products into a common flow path such that the base products combine to form a layered, co-extruded product stream, and die means for receiving the layered co-extruded product stream, the die means being arranged so as to divide the layered co-extruded product stream into at least two separate sub-streams of layered co-extruded product which rotate about each other and to subsequently recombine the at least two sub-streams into a single recombined product stream.

In the apparatus in accordance with the invention, the layered co-extruded product is divided into separate steams of product that spiral about each other so that the disposition of the streams relative to each other can be varied before the streams are recombined. Because the two streams are moved around each other before being recombined, the layers in the co-extruded product can be manipulated so that the end product has a striped or variegated appearance.

The at least two sub-streams may follow a generally helical path around each other.

The apparatus may further comprise a cutter means for dividing the recombined product stream into at least two ropes, each rope having a striped or variegated effect.

The die means may include at least one body member defining a flow passage and a generally helical blade or screw statically mounted in the passage to divide the passage into two generally helical flow paths, one for each of the sub-streams.

The generally helical blade may comprise two or more generally helical blade members arranged in series, each blade member being angularly offset relative to an adjacent blade member, such that the respective flow paths defined by said adjacent blade members are offset.

The use of two or more blade members has the advantage of increasing the amount of manipulation of the co-extruded product to increase and/or vary the visual effect achieved. Furthermore, by varying the amount of offset between the blade members and the length of the blade members, the nature of the visual effect created can also be altered.

In one embodiment, all the generally helical blade members are provided in a passage of a common body member so that the relationship between the blade members is fixed.

In an alternative embodiment, the die means has at least two body members which are releasable assembled together, each body member defining a flow passage and having at least one generally helical blade member statically mounted in the passage to divide the passage into two generally helical flow paths. The relative orientation of the body members may be adjustable to vary the angular offset between the blade members in the body members. This arrangement has the advantage that the offset between the blade members can be adjusted to vary the visual effect in the final product. Additionally, it is possible to produce a range of different length body members which can be assembled in various combinations to vary the visual effect achieved in the final product.

The apparatus may be adapted for use in producing a confectionary product.

In accordance with a second aspect of the invention, there is provided a method of producing a product having a striped or variegated appearance, the method comprising:

co-extruding at least two base products to form a layered, co-extruded product stream;

dividing the layered co-extruded product stream into at least two separate sub-streams, each sub-stream containing layers of the at least two base materials;

rotating the sub-streams about each other to re-orientate layers in one of the sub-streams relative to the layers in at least one other of the sub-streams; and

recombining the re-oriented sub-streams of co-extruded product to form a single recombined product stream.

The method may also comprise cutting the recombined product stream into at least two ropes.

The method may comprise dividing the co-extruded product into a first pair of separate sub-streams and rotating the first pair of sub-streams about each other and subsequently dividing the product into a further pair of sub-streams and rotating the further pair of sub-streams about each other before recombining the further pair of sub-streams, the further pair of sub-streams being offset relative the first pair of sub-streams.

The step of dividing the co-extruded product stream into at least two sub-streams may be carried out using a helical blade or screw mounted statically in a flow passage. The helical blade or screw may include two or more blade members, each blade member being angularly offset relative to an adjacent blade member. The angular offset between all the blade members may be fixed or the angular offset between at least some of the blade members can be adjustable.

The method may comprise providing a plurality of body members, each defining a flow passage with at least one generally helical blade member mounted therein to divide the passage into two generally helical flow paths, the body members being connectable to form the means for dividing the co-extruded product into the at least two separate sub-streams.

The product is preferably a confectionary product.

### BRIEF DESCRIPTION OF THE DRAWINGS

An embodiment of the invention will now be described, by way of example only, with reference to the accompanying drawings, in which:

FIG. 1 is a cross-sectional view through an apparatus in accordance with a first aspect of the invention;

FIG. 2 is a perspective view of part of the apparatus of FIG. 1;

FIG. 3 is a perspective view of a nozzle of the apparatus of FIG. 1;

FIG. 4 is a perspective view showing the relative positions of a nozzle and an adapter plate of the apparatus of FIG. 1; and,

FIG. 5 is a schematic cross sectional view taken on line A-A of FIG. 1;

FIG. 6 is a schematic cross sectional view taken on line B-B of FIG. 1;

FIG. 7 is a schematic cross sectional view taken on line C-C of FIG. 1;

FIG. 8 is a schematic cross sectional view taken on line D-D of FIG. 1; and,

FIGS. 9a and 9b show products having different visual effects created using the apparatus of FIG. 1.

### DETAILED DESCRIPTION OF THE INVENTION

With reference to the drawings, apparatus in the form of a die for producing a striped or variegated product in accordance with the invention is indicated generally at 10.

The die 10 includes an inlet nozzle 12, an adapter plate 14, a connection plate 16, a twist member 18, and a final cutter 20.

The inlet nozzle 12 and the adapter plate 14 are adapted to be mounted to a twin extruder (not shown) to enable two base products A, B to be co-extruded to form a layered, co-extruded product in a manner known in the art. To this end, the inlet nozzle 12 has a circular flange 22 for mounting to the extruder and a main, tapered body portion 24 that extends from the circular flange to a generally rectangular nose portion 26. A passageway 28 is formed through the nozzle. The passageway includes a generally conical inlet portion 30 which tapers into a generally rectangular passageway 31 extending through the nose portion 26 to define an outlet 32.

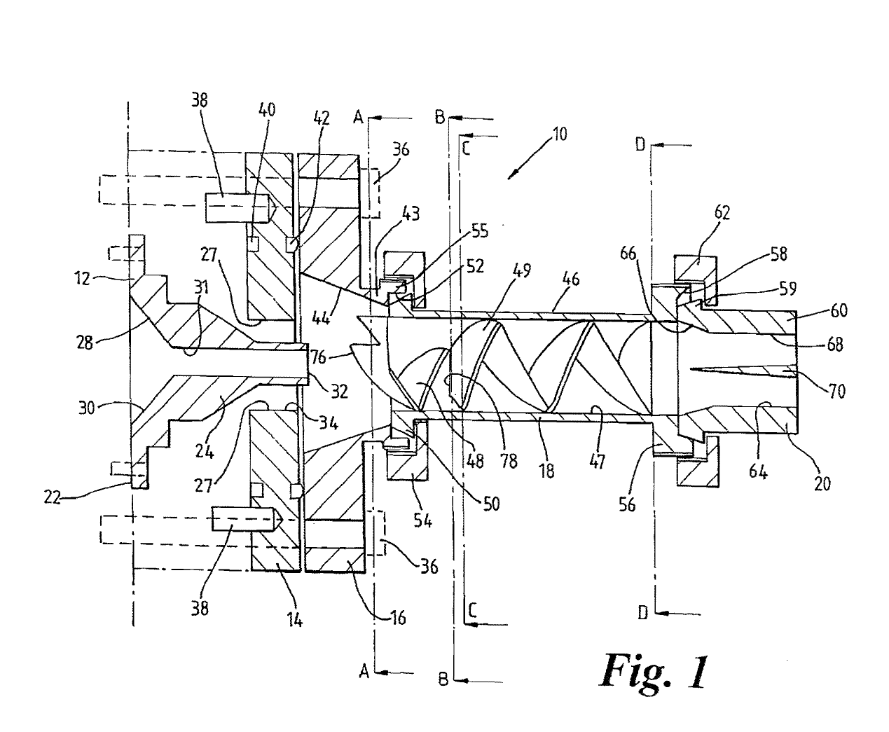

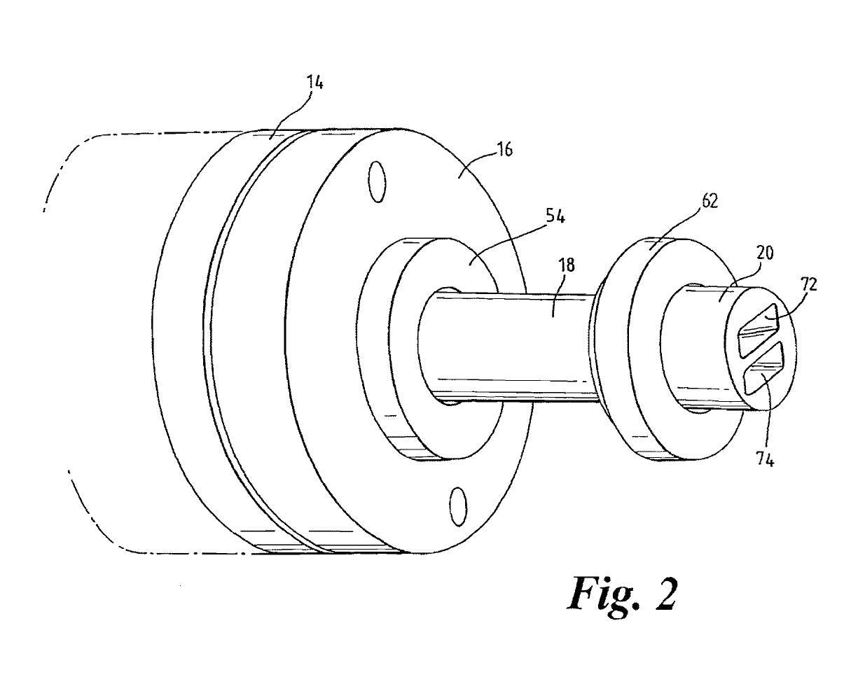

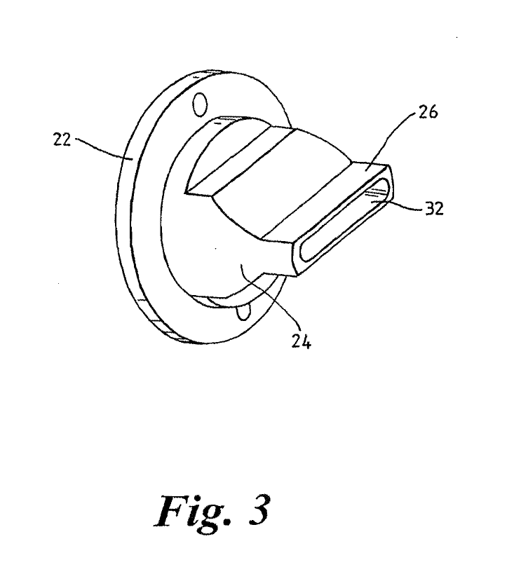

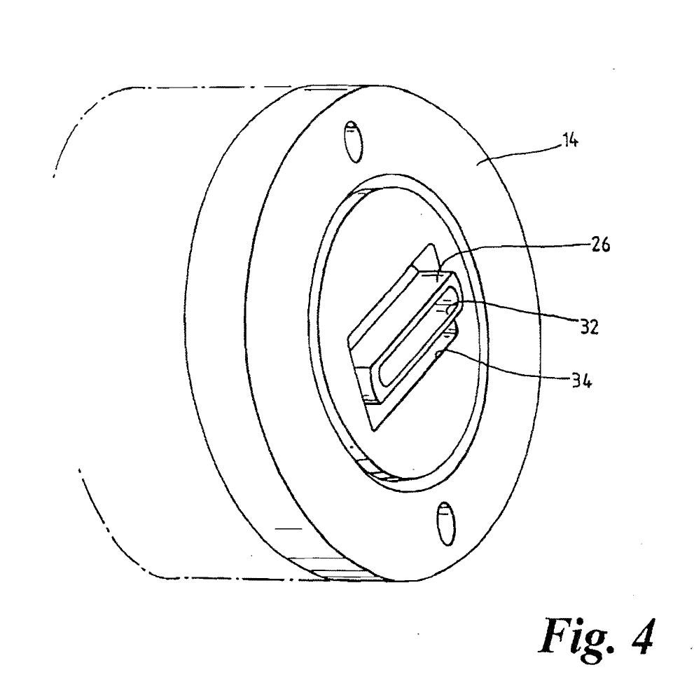

The adapter plate 14 is circular and is provided with a central, generally rectangular opening 34, which receives the nose portion 26 of the inlet nozzle. The width of the opening 34 is approximately the same as the width of the nose portion 26, so that the nose portion can be received in the opening with a minimum clearance at the sides. However, the height of the opening 34 is larger than the height of the nose portion 26, so that, as can best be seen in FIG. 1, clearances 27 are provided above and below the nose portion 26 when it is received in the opening 34.

The adaptor plate is held in position on the extruder by the connection plate 16. As shown in ghost in FIG. 1, bolts 36 pass through corresponding holes in the connection plate 16 and adaptor plate 14 to secure the plates to the extruder. Studs 38 may be provided on the inner face of the adaptor plate for engagement in corresponding holes on the extruder to accurately position the adaptor plate.

Seal means 40, 42 are provided to seal between the adaptor plate 14 and the extruder and between the adaptor plate 14 and the connection plate 16 respectively.

On the side of the connection plate 16 facing away from the adaptor plate is a flange 43 to which the twist member 18 is mounted by means of a quick release fitting, as will be described later. An opening 44 is provided through the connection plate 16. The opening 44 is aligned with the opening 34 in the adapter plate 14 and the outlet 32 of the nozzle. The opening 44 is generally conical, tapering from its widest point at the side adjacent the adapter plate to its narrowest point on the side adjacent the twist member.

The twist member 18 comprises a tubular body 46 defining a cylindrical passage 47 and has two generally helical or spiral blade members 48, 49 mounted statically within the passage 47. The outer diameters of the helical blade members 48, 49 are substantially the same as the diameter of the passage 47 through the tubular body 46 so that each blade member defines two generally helical flow paths in the passage 47, one on either side of the blade member.

One end of the body 46 has a tapered flange 50 that projects radically outwardly and is adapted to be received in a recess 52 formed in the flange 44 of the connection plate. A connector ring 54 is loosely mounted about the body of the twist member 18 and is adapted to cooperate with formations 55 on the outer diameter of the flange 43 to firmly connect the twist member 18 to the connection plate 16. Preferably, the connection ring 54 and the formations 55 on flange 43 are arranged to provide a quick release fitting for connecting the twist member 18 to the connection plate 18 in a manner known in the art. For example, the connection ring 54 and the formations 55 on the flange 43 may be adapted to provide a bayonet or other type of twist-fit quick release connection.

At the opposite end of the tubular body 46 from the tapered flange 50 is a further radial flange 56 to which the final cutter 20 is mounted. The flange 56 has a recess 58 formed in its outer face which is adapted to receive a flange 59 formed on one end of a tubular body 60 of the cutter 20. A further connection ring 62, similar to connection ring 54, is mounted about the body of the cutter. The connection ring 62 cooperates with formations on the further flange 56 of the twist member to provide a quick release connection means for firmly mounting the cutter 20 to the twist member 18.

A passageway 64 extends through the final cutter. A first portion 66 of the passageway is generally conical and tapers into a generally rectangular second portion 68. The second portion of the passageway 68 is divided into two by a cutter blade 70 to provide two generally rectangular outlet openings 72, 74.

The first generally helical blade member 48 in the twist member 14 is located in the upstream end of the passageway 47 and its leading edge protrudes from the forward end of the twist member 18 so as to project into the opening 44 in the connection plate 16. The leading edge of the first blade member 48 forms a first cutting edge 76 which acts to dived the co-extruded product flowing through the passageway 44 into two separate sub-streams which flow along the paths on either side of the first blade member 48, as will be described in more detail later.

The second generally helical or spiral blade member 49 is located downstream from the first blade member 48 and is angularly offset relative the first blade member 48. The angular offset between the first and second blades 48, 49 is selected to provide a desired visual effect of the final product. In the present embodiment, the second blade member 49 is offset by approximately 90 degrees relative to the first blade member 48 to produce a striped effect in the final product.

The leading edge of the second blade member 49 adjacent the first blade member 48 provides a second cutting edge 78 which extends across the flow paths formed on either side of the first blade member 48. The second cutting edge acts to divide the co-extruded product flowing in the two sub-streams on either side of the first blade member 48 into two new sub-steams flowing one on either side of the second blade member 49.

The adapter plate 14, the connecter plate 16, and the twist member 18 may be warmed by any suitable means, such as an electrical heating tape (not shown) connected to a temperature controller (also not shown). The required temperature will vary depending on the product to be extruded but is likely to be in the range of 45 to 75 degrees Celsius for most confectionary products.

Suitable sealing means may be provided between the various components of the die 10 as is well known in the art.

Operation of the apparatus 10 will now be described.

A first base product A is extruded through the passageway 28 in the nozzle 12 to form a generally rectangular first layer in the opening 44 in the connection plate 16. A second base product B is extruded between the nozzle 12 and the adapter plate. The second base product passes through the clearances 27 between the top and bottom surfaces of the nose portion 26 of the nozzle and the opening 34 in the adapter plate 12 into the opening 44 in the connection plate, where it forms layers on either side of the layer of the first base product. The result is the formation of co-extruded product in the opening 44 having three layers in which a middle layer of the first base product is sandwiched between outer layers of the second base product.

As the co-extruded product advances through the opening 44 in the connection plate, it meets with the first cutting edge 76 of the first blade member 48. The first cutting edge 76 divides the co-extruded product into two sub-streams one flowing along each side of the first helical blade member. The first cutting edge 76 is arranged so that it divides the co-extruded product along a line that extends across all three layers of the co-extruded product in the opening 44. Preferably, the first cutting edge 76 extends at an angle of approximately 90 degrees to the orientation of the layers. In the present embodiment, the layers of the co-extruded product are aligned generally horizontally and the first cutting edge 76 is aligned to extend generally vertically. It will be understood, however, that the alignment of the layers need not be horizontal and the alignment of the first cutting edge need not be vertical.

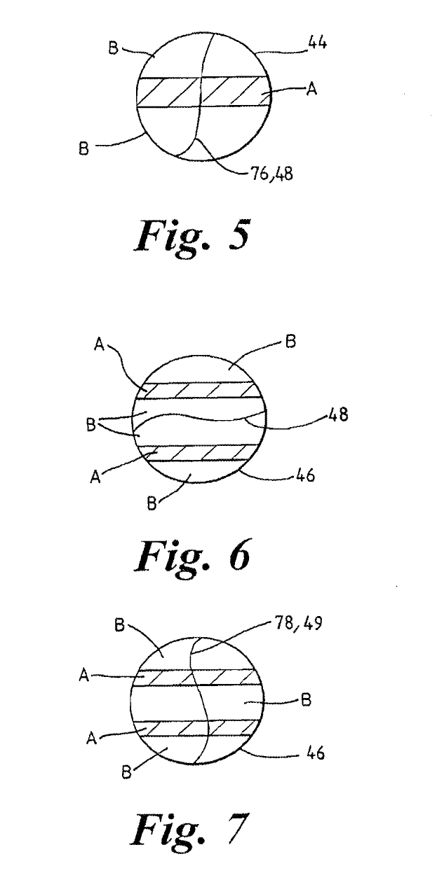

As the co-extruded product enters the flow paths on either side of the first helical blade member it forms two separate sub-streams each having three layers of the base products arranged side by side as shown in FIG. 5. Because the flow paths defined by the first helical blade are spiralled or helical, the sub-streams rotate about each other as they progress along the length of the first blade member 48. In the present embodiment, the length of the first blade member is such that the two sub-streams are positioned one above the other as they near the end of the first blade. However, the layers of base product in each of the sub-streams will tend to remain horizontally aligned, hence as the streams exit the first blade member 48 they, in effect, produce a stack of five layers of the base products A, B as illustrated in FIG. 6.

As the sub-streams of co-extruded product exit the first helical blade member 48, they encounter the second cutting edge 78 on the second helical blade member 49. The second blade member 49 is offset by about 90 degrees relative to the first blade member 48 such that the cutting edge 78 extends approximately perpendicularly to the end 80 of the first blade and to the layers of base product in the two streams exiting the first blade member. The second cutting edge 78 thus divides the sub-streams of product exiting the first blade member 48 into two new sub-streams, one on either side of the second blade. Because of the relative positions of the two blade members, each of the new sub-streams has five layers of the basic products, as is depicted in FIG. 7.

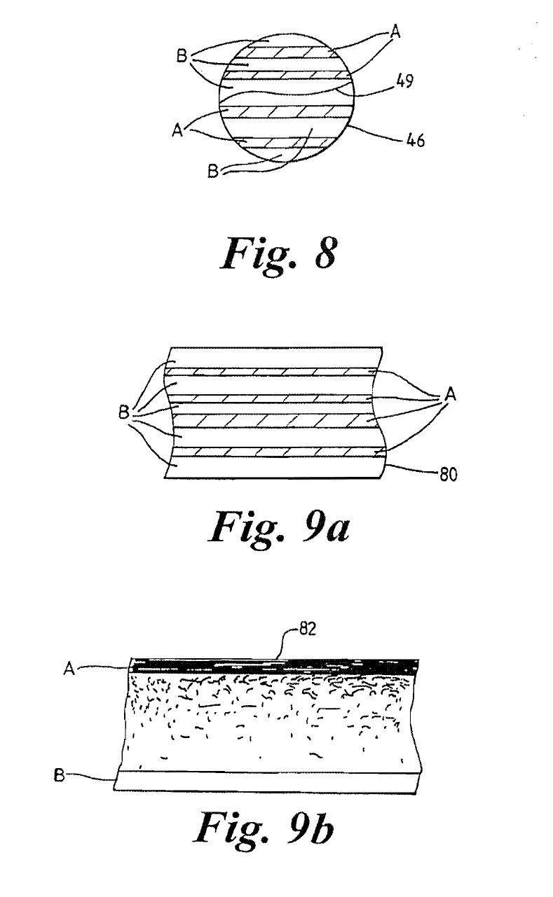

As the new sub-streams enter the flow paths on either side of the second blade they are again aligned generally side by side as shown in FIG. 7. However, as the sub-streams progress along the flow paths they spiral about each other and the arrangement is such that as they exit the second blade, they are arranged generally one above the other, as illustrated in FIG. 8. Once again, the layers in the sub-streams flowing about the second blade member tend to remain aligned generally horizontally so that as the sub-streams exit the second blade member 49, they recombine to form a single recombined steam of product having a stack of nine layers of the two base products A, B.

The recombined and re-stacked stream of co-extruded product then passes through the final cutter 20 where it is formed into two ropes. The cutter 20 is aligned to ensure that the recombined product is divided along an axis that reveals the striped formation.

The visual effect produced in the final product can be varied by altering the lengths of the first and second helical blade members 48, 49 and by altering the angle of the offset between them. FIG. 9a illustrates a product 81 having a striped finish produced as described generally above. FIG. 9b illustrates a product having a variegated or “rainbow” type effect in which there is a predominance of one of the base products A on one side and a predominance of the other of the base products B on the other side with a gradual variation in the middle.

In the present embodiment, the first and second helical blade members 48, 49 are provided in a common tubular body 46. However, the two blade members 48, 49 could be provided in separate tubular body members that can be connected together, for example by means of a quick release connector similar to that used to mount the final cutter 20 to the twist member 18. This has the advantage that the offset between the first and second blade members 48, 49 can be easily adjusted. It also allows a range of different length blade members to be provided which can be interchanged to produce the desired visual effect in the final product.

The helical blade members 48, 49 may in the form of screws welded or otherwise fixed in the tubular body member(s), the leading ends of the screws being shaped to form the first and second cutting edges 76, 78. However, any suitable means of defining the helical flow paths can be used.

A variety of base products can be used to produce different effects. The base products may differ only in colour. For example the apparatus can be used to extrude product comprising gums or soft chews of different colours. Alternatively, or additionally, the base products may differ in taste and/or texture. In this case one of the products may be a gum and the other a soft chew. These are of course only examples and those skilled in the art will be able to device numerous alternative products and combinations that can be adapted for use with the invention. Furthermore, it should be understood that more than two different base products can be used.

The product produced by the die 10 described above may be subject to further treatment or processing. For example the ropes of product leaving the final cutter may be covered in an outer coating so that the striped effect is only revealed when the product is bitten into or the outer coating removed.

Whereas the invention has been described in relation to what is presently considered to be the most practical and preferred embodiments, it is to be understood that the invention is not limited to the disclosed arrangements but rather is intended to cover various modifications and equivalent constructions included within the spirit and scope of the invention. For example, whilst the invention has primarily been described in relation to a confectionary product, it will be appreciated that invention could be used to create similar effects in non-confectionary extruded products.

Where the terms “comprise”, “comprises”, “comprised” or “comprising” are used in this specification, they are to be interpreted as specifying the presence of the stated features, integers, steps or components referred to, but not to preclude the presence or addition of one or more other feature, integer, step, component or group thereof.

1. An apparatus for producing a striped confectionery product, the apparatus comprising:
a co-extruding device for co-extruding at least two different base products into a common flow path, said co-extruding device including elongate openings extending laterally across the flow path generally parallel to one another through which said base products are introduced into said common flow path so as to form a combined co-extruded product stream comprising layers of said base products aligned generally parallel to one another; and
a die for receiving the layered co-extruded product stream, said die having at least one body member defining a passage and a generally helical blade statically mounted in said passage to divide said passage into two generally helical flow paths, said blade having a cutting edge which is angled so as to divide the layered co-extruded product stream into two separate sub-streams of co-extruded product which each comprise layers of the base products and to direct said sub-streams along the helical flow paths about each other, said die being configured so that said sub-streams are subsequently recombined into a single recombined product stream having an increased number of generally parallel layers of said base products when compared with the initial co-extruded product stream.

2. An apparatus as claimed in claim 1, further comprising
a cutter for dividing the recombined product stream into at least two ropes, each rope having a striped effect.

3. An apparatus as claimed in claim 1, in which said generally helical blade includes two or more generally helical blade members arranged in series, each blade member being angularly offset relative to an adjacent blade member, such that the respective flow paths defined by said adjacent blade members are offset.

4. An apparatus as claimed in claim 3, in which said at least two generally helical blade members are provided in a passage of a common body member so that the relationship between said blade members is fixed.

5. An apparatus as claimed in claim 3, in which said die includes at least two body members which are releasable assembled together, each body member defining a through passage and having at least one generally helical blade member statically mounted in the passage to divide the passage into two generally helical flow paths.

6. An apparatus as claimed in claim 5, in which the relative orientation of said body members can be adjusted to vary the angular offset between said blade members in the respective said body members.

7. An apparatus as claimed in claim 1, in which the apparatus comprises three elongate openings extending laterally across the flow path generally parallel to one another such that three, generally parallel layers of base products are formed in the initial co-extruded product stream.

8. An apparatus for producing a striped confectionary product, the apparatus comprising:
an adapter plate with an opening for transmitting a first base product;
a body having a rectangular passageway for transmitting a second base product, said opening sub-partitioned by said rectangular passageway to produce at least a non-discontinuously three-layered combined co-extruded product stream from said base products;
a tubular body member having at least a helical blade member to sub-divide said three-layered combined co-extruded product stream into two separate product streams which combined produce increased number of layers; and
an actuator to move forward said first and second base product from said opening and said rectangular passageway into said tubular body.

9. A method of producing a confectionary product having a striped appearance, the method comprising:
co-extruding at least two base products to form a co-extruded product stream comprising generally parallel layers of said base products extending laterally across a flow path;
dividing the layered co-extruded product stream into at least two separate sub-streams, each sub-stream containing layers of said at least two base products;
rotating said sub-streams about each other to re-orientate layers in one of said sub-streams relative to said layers in at least one other of said sub-streams; and
recombining said re-oriented sub-streams of co-extruded product to form a single recombined product stream comprising an increased number of generally parallel layers of said base products when compared with said initial co-extruded product stream.

10. A method as claimed in claim 9, the method further comprising:
cutting the recombined product stream into at least two ropes.

11. A method as claimed in claim 9, the method further comprising:
dividing said co-extruded product into a first pair of separate sub-streams and rotating said first pair of sub-streams about each other and subsequently dividing said product into a further pair of sub-streams and rotating the further pair of sub-streams about each other before recombining said further pair of sub-streams, said further pair of substreams being offset relative said first pair of sub-streams.

12. A method as claimed in claim 9, in which the step of dividing said co-extruded product stream into at least two sub-streams is carried out using a helical blade or screw mounted statically in a flow passage.

13. A method as claimed in claim 12, in which said helical blade or screw comprises two or more blade members, each blade member being angularly offset relative to an adjacent blade member.

14. A method as claimed in claim 13, in which said angular offset between said blade members is fixed.

15. A method as claimed in claim 13, in which said angular offset between at least some of said blade members can be adjusted.

16. A method as claimed in claim 13, the method comprising providing a plurality of body members, each defining a flow passage with at least one generally helical blade member mounted therein to divide said passage into two generally helical flow paths, said body members being connectable to form a divider for dividing said co-extruded product into said at least two separate sub-streams.

17. A method as claimed in claim 9, in which said initial co-extruded product stream comprises three generally parallel layers of said base products.

18. A method of producing a confectionery product having a striped appearance, the method comprising the steps of:
actuating a first base product through an opening of an adapter plate;
actuating a second base product through a rectangular passageway of a body, wherein said opening is sub-divided by said rectangular passageway to facilitate production of a non-discontinuous three-layered combined co-extruded product stream from said base products; and
actuating said co-extruded product stream into a tubular body member having at least a helical blade member to sub-divide said three-layered combined co-extruded product stream into two separate product streams which combine to produce increased number of layers.

19. An apparatus according to claim 8, wherein said second base product is not bounded by said first base product at either ends in said product stream and said first base product contacts said second base product only at a plane after exiting said opening and said passageway.

20. A method according to claim 18, wherein said second base product is not bounded by said first base product at either ends in said product stream and said first base product contacts said second base product only at a plane after exiting said opening and said passageway.
